(19) United States
(12) Patent Application Publication
(10) Pub. No.: US 2009/0047927 A1
(43) Pub. Date: Feb. 19, 2009

(54) Method for Operating a Radio Network and Subscriber Device for Said Type of Network

(76) Inventor: Christoph Weiler, Bretten (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/086,439

(22) PCT Filed: Dec. 13, 2006
(86) PCT No.: PCT/EP2006/069634

§ 371 Date: Jun. 12, 2008

(30) Foreign Application Priority Data
Dec. 14, 2005 (DE) 10 2005 059 800.5

(51) Int. Cl. H04M 11/00; H04W 4/12; H04W 40/00

(52) U.S. Cl. 455/405; 455/466; 455/445

(57) ABSTRACT

There is described a method for operating a radio network for transferring data between several subscribers, in particular, between devices of process instrumentation in an automation system. At least one first subscriber communicates in a telegram the requests thereof relating to the frequency of the data transfer to other subscribers in a starting phase. During network optimization, a configuration device determines, in the radio network and according to the frequency of the requests of other subscribers, at least one communication partner to which a connection comprising the frequency of the data transfer, which is adapted to the other subscribers, is established. As the periods of data transfer are planned, it is possible to switch off the communication interface of the first subscriber in the pauses and also, to save energy.

### CROSS REFERENCE TO RELATED APPLICATIONS

This application is the US National Stage of International Application No. PCT/EP2006/069634, filed Dec. 13, 2006 and claims the benefit thereof. The International Application claims the benefits of German application No. 10 2005 059 800.5 DE filed Dec. 14, 2005, both of the applications are incorporated by reference herein in their entirety.

### FIELD OF INVENTION

The invention relates to a method for operating a radio network for transmitting data between a number of subscribers, in particular between process instrumentation devices in an automation system, and a subscriber device.

### BACKGROUND OF INVENTION

DE 101 25 387 A1 has already disclosed a radio network for transmitting data between a number of subscribers, which can also be referred to as subscriber devices. The network has a number of radio cells, in which at least one base station for the wireless transmission of data with subscribers in the radio cell is arranged in each instance. So that the radio signals in adjacent radio cells, which overlap at least partially, do not interfere with one another, different channels are used in each instance for wireless data transmission in overlapping radio cells. When a subscriber with a radio link moves from one radio cell to an adjacent radio cell, a transfer method or so-called handover is required from one cell to the other. The mobile subscribers evaluate the signal quality and change transmission channel depending on the result of the evaluation, in order to perform communication with a base station on the transmission channel with the best transmission characteristics in each instance. To minimize delay time when switching a mobile subscriber to a new channel, the base stations simultaneously carry out test cycles, in which said base stations transmit test signals into the respective radio cells, on the basis of which subscribers with a radio link determine the transmission channel with the best transmission characteristics. The method is suitable for networks provided for time-critical applications, for example for networking sensors and actuators as process instrumentation devices in an automation system.

Automation systems increasingly use autonomous sensors, in other words sensors having no connecting wires for communication or energy supply purposes. They can be installed in the system with particularly little outlay. They are provided with an energy source or energy storage unit to supply them with the required operating energy. The quantity of energy available is hereby frequently limited. It is required to acquire the sensor value, in some instances to preprocess the acquired values and to transmit the acquired values by way of the radio network.

### SUMMARY OF INVENTION

An object of the invention is to find a method for operating a radio network for transmitting data between a number of subscribers, in particular between process instrumentation devices in an automation system, and to create a suitable subscriber device for this purpose, with which the quantity of energy required for data transmission is reduced.

To achieve this object the new method for operating a radio network has the features specified in an independent claim. Advantageous developments are described in the dependent claims and a subscriber device is described in a further independent claim.

The invention has the advantage that the communication partners most suitable for a subscriber based on the latter's requirements relating to data transmission frequency are automatically determined for said subscriber. A connection is set up only between the subscriber and the communication partners thus determined. This makes it possible for the subscriber to deactivate its communication interface at times when no communication is taking place, thereby saving supplied energy. It is thus possible for a subscriber to achieve full communication capability according to its requirements with a minimal energy requirement. Therefore minimization of the energy requirement is taken into account as well as an automatic configuration with appropriate discovery mechanisms. Standard methods for configuring radio networks negotiate the data rate as well as the security mechanisms used. This is done for example by finding the maximum data rate achieved by all the communication partners involved. The data rate to be set corresponds to the data rate of the communication partner whose maximum data rate is the lowest. The invention also makes it possible to find suitable communication partners in the radio network based on the data transmission frequency required by a subscriber. Data transmission periods can then be organized in cycles, in which pauses, during which the communication interface of the partner involved can be disconnected, alternate with data transmission periods, in which all the partners involved activate their communication interfaces. It can be taken into account here that subscribers with routing capability have to remain active at all times, as data requiring immediate forwarding can be sent at any time.

In a structured radio network for example, in which a number of subscribers, for example wireless sensors, establish connections to an access point, the method can be used to determine the most suitable access point. If a number of access points are available, a connection is established between the subscriber and the access point, which meets the requirements set by the subscriber best. It is for example ensured in this manner that a sensor does not connect unnecessarily to a high-performance access point. On the other hand the access point can use the requirements received from a subscriber relating to data transmission frequency to decide whether or not to reject a connection to the respective subscriber.

In meshed radio networks in particular the invention has the advantage that subscribers whose cyclical data transmission has a similar cycle duration can connect to one mesh. It is then possible to synchronize subscribers to this cycle. To reduce power consumption subscribers wake up before the start of the data transmission period and transmit their waiting data. In other words the radio interface is only switched to active for this period. The time window, in which subscribers are in an awake state, must therefore be set so that all the communication partners involved can also actually communicate during this period. The temporal position of the transmission period can be synchronized when the subscribers are in the awake phase. This ensures that the position of the transmission periods does not differ for the different communication partners.

With sensors with an autonomous energy supply as communication partners in particular the possibility of limiting communication activities to specific periods, thereby minimizing the energy requirement, is of major importance. As a result it is possible to operate the sensor with a smaller energy storage unit or to use a smaller energy source. On the other hand maintenance operations, in which an energy storage unit is replaced, can be carried out at longer intervals for energy storage units of the same size. Because every sensor makes its required transmit cycle known, sensors with similar transmit cycles can establish themselves as communication partners and connect to a mesh. The sensors connected to a mesh can agree a common communication cycle, which still satisfies the requirements of the most demanding communication partner. Unnecessarily frequent communication is hereby avoided and energy is saved.

In the case of networks structured with access points it is advantageously possible to optimize the interfacing of the sensors with autonomous energy supplies to the access points. Since every sensor makes its requirements relating to data transmission frequency known, communication can be planned and the access points can distribute the load appropriately.

If the first subscriber notifies the further subscribers of the time period during which it will not take part in communication between two data transmissions, this has the advantage that it can deactivate its communication interface completely between two data transmissions. For example an access point can use this information to decide whether data is forwarded by radio to a sensor connected to it or is stored in the access point, until the sensor has once again activated its communication interface.

Also the first subscriber can notify further subscribers of its functional characteristic in the radio network determining whether it can be operated as a router and the configuration facility can determine the mesh structure of a meshed radio network as a function of the notified functional characteristic. This advantageously allows the automatic setting up of an optimized meshed radio network. With such optimization it is of course also possible to take into account the data rate required by the subscribers and the notified requirements relating to data transmission frequency.

### BRIEF DESCRIPTION OF THE DRAWINGS

The invention, along with embodiments and advantages, is described in more detail below with reference to the drawings, which illustrate an exemplary embodiment of the invention and in which:

FIG. 1 shows a meshed network,

FIG. 2 shows two time diagrams with communication cycles and

FIG. 3 shows a subscriber device.

### DETAILED DESCRIPTION OF INVENTION

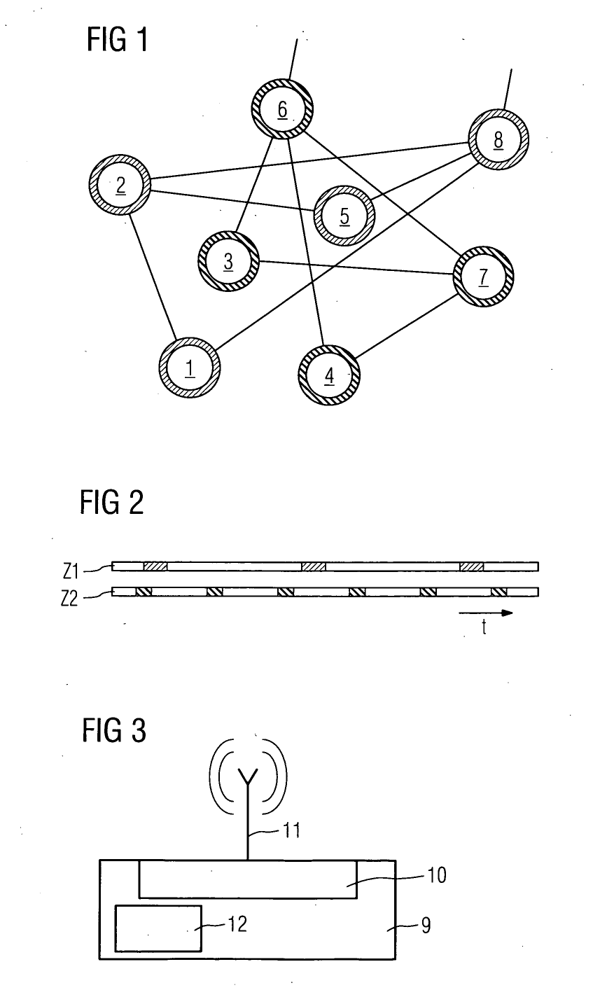

FIG. 1 shows an exemplary radio network with eight subscriber devices 1 . . . 8. In a start-up phase the subscriber devices 1 . . . 8 respectively send telegrams to notify the respective other subscriber devices of their requirements relating to data transmission frequency. During network optimization a configuration facility, which can be arranged centrally in the subscriber device 1 for example, determines from the subscriber devices 1 . . . 8 the communication partners, which suit one another best with regard to their requirements. In the meshed radio network shown in FIG. 1 this is done by means of a grouping, in which different subscriber devices are respectively connected together to form an independent meshed network. This can take place in such a manner that the subscribers start up temporally one after the other. Each subscriber broadcasts its requirements/functions, which are possible in the respective system, on all channels. It then receives a response from all the stations visible at this point with information about their requirements/possibilities. This procedure ensures that they all always know their neighbors and their requirements/possibilities and an optimum structure can thus be created. In this manner the subscriber devices 1, 2, 5 and 8 form a first meshed network and the subscriber devices 3, 4, 6 and 7 form a second meshed network. Different channels are used for communication in the two meshed networks of the radio network, so the two networks do not interfere with one another. In the exemplary embodiment illustrated the radio network has autonomous sensors as subscriber devices 1 . . . 8. An uplink node to link the network to a higher-order system, for example as part of the controller of a technical process, is therefore provided in each meshed network. In the first meshed network the subscriber device 8 forms the uplink node, in the second meshed network the subscriber device 6, as shown in the drawing by a connecting line with an open end. The two subscriber devices 6 and 8 have been given the function of uplink nodes since they notified the other subscriber devices that they have the capability of being operated as routers in a meshed network.

During configuration of the radio network further requirements of subscriber devices, for example the data rate or telegram size, or further functional characteristics, for example whether the subscriber device is an end node or a gateway node in a radio network, can also be taken into account. This results in further optimization possibilities when determining the network topology and setting the communication parameters.

As an alternative to the exemplary embodiment described, the configuration facility can be executed in a non-central manner, so that a configuration facility is provided in each subscriber device 1 . . . 8 and the subscriber devices 1 . . . 8 agree or negotiate the temporal parameters of communication cycles according to their respective requirements relating to data transmission frequency.

FIG. 2 shows temporal sequences Z1 and Z2 of communication cycles, which are used in the first meshed network and/or the second meshed network as a result of the configuration of the network according to FIG. 1. The data transmission periods are shown respectively with hatched areas, with the intervals between data transmissions being shown with white fields. Since the subscriber devices 1, 2, 5 and 8 permit longer intervals between the individual data transmission periods, these are brought together as communication partners in the first mesh, where there is a longer interval between data transmission times. In the pauses between two data transmissions the subscriber's communication interface can be disconnected completely. This allows a considerable energy saving in the subscriber devices, in particular in autonomous sensors as process instrumentation devices. In the second meshed network made up of the subscriber devices 3, 4, 6 and 7 shorter intervals are required between data transmissions. Therefore the data transmission periods follow one another at shorter time intervals in the communication cycle Z2.

FIG. 3 shows a subscriber 9 with a radio interface 10, which has an antenna facility 11. This is preferably an autonomous sensor with its own energy supply, for example from a battery. A configuration facility 12 of the subscriber 9 determines the most suitable communication partners based on its requirements relating to data transmission frequency in the radio network where the subscriber 9 is located. Once connections to these communication partners have been set up and temporal communication parameters have been negotiated, data transmission takes place in synchronized communication cycles. The radio interface 10 is completely deactivated in the pauses between radio transmission. The subscriber device 9 can therefore manage with a very small quantity of energy.

1.-4. (canceled)

5. A method for operating a radio network for transmitting data between a plurality of subscribers, comprising:
at least one first subscriber is notifying further subscribers in a telegram of its requirements relating to a data transmission frequency in a start-up phase;
determining at least one communication partner by a configuration facility in the radio network as a function of the requirements from the further subscribers during a network optimization; and
setting up a connection between the first subscriber and the determined communication partner with a data transmission frequency tailored to each of them.

6. The method as claimed in claim 5, wherein the subscribers are process instrumentation devices in an automation system.

7. The method as claimed in claim 5, wherein the first subscriber notifies further subscribers of the period for which it will not take part in communication between two data transmissions.

8. The method as claimed in claim 6, wherein the first subscriber notifies further subscribers of the period for which it will not take part in communication between two data transmissions.

9. The method as claimed in claim 5, wherein the first subscriber notifies further subscribers of its functional characteristic in the radio network determining whether it can be operated as a router and wherein the configuration facility in the radio network determines the mesh structure of the radio network as a function of the functional characteristic.

10. The method as claimed in claim 6, wherein the first subscriber notifies further subscribers of its functional characteristic in the radio network determining whether it can be operated as a router and wherein the configuration facility in the radio network determines the mesh structure of the radio network as a function of the functional characteristic.

11. The method as claimed in claim 7, wherein the first subscriber notifies further subscribers of its functional characteristic in the radio network determining whether it can be operated as a router and wherein the configuration facility in the radio network determines the mesh structure of the radio network as a function of the functional characteristic.

12. The method as claimed in claim 8, wherein the first subscriber notifies further subscribers of its functional characteristic in the radio network determining whether it can be operated as a router and wherein the configuration facility in the radio network determines the mesh structure of the radio network as a function of the functional characteristic.

13. The method as claimed in claim 5, wherein at least one subscriber is a measuring transducer.

14. A subscriber device, comprising:
a configuration such that in a start-up phase the subscriber device notifies further subscribers in a telegram of its requirements relating to data transmission frequency, such that during network optimization a configuration facility in the radio network determines at least one communication partner as a function of the requirements from the further subscribers and the subscriber device sets up a connection to the determined communication partners with a data transmission frequency tailored to each of them.

15. A measuring transducer for a radio network, comprising:
a configuration such that in a start-up phase the subscriber device notifies further subscribers in a telegram of its requirements relating to data transmission frequency, such that during network optimization a configuration facility in the radio network determines at least one communication partner as a function of the requirements from the further subscribers and the subscriber device sets up a connection to the determined communication partners with a data transmission frequency tailored to each of them.
